(19) United States
(12) Patent Application Publication
(10) Pub. No.: US 2017/0371573 A1
(43) Pub. Date: Dec. 28, 2017

(54) METHOD OF OPERATING STORAGE MEDIUM, METHOD OF OPERATING HOST CONTROLLING THE STORAGE MEDIUM, AND METHOD OF OPERATING USER SYSTEM INCLUDING THE STORAGE MEDIUM AND THE HOST

(71) Applicant: Samsung Electronics Co., Ltd., Suwon-si (KR)

(72) Inventors: Chansol KIM, Seoul (KR); Byung-Gook KIM, Hwaseong-si (KR); Jisoo KIM, Seongnam-si (KR); Jin-Hwan PARK, Yongin-si (KR); Pilsung KANG, Hwaseong-si (KR); Kyung Ho KIM, Seoul (KR); Chaewon YU, Suwon-si (KR); Sojeong LEE, Hwaseong-si (KR); Bongjun CHOI, Hwaseong-si (KR); Taeseok HWANG, Hwaseong-si (KR)

(73) Assignee: Samsung Electronics Co., Ltd., Suwon-si (KR)

(21) Appl. No.: 15/583,256

(22) Filed: May 1, 2017

(30) Foreign Application Priority Data
Jun. 24, 2016 (KR) 10-2016-0079512
Aug. 31, 2016 (KR) 10-2016-0111902

(51) Int. Cl. G06F 3/06; G06F 12/14; G06F 21/44

(52) U.S. Cl. CPC G06F 3/0622; G06F 21/44; G06F 12/1458; G06F 3/0619; G06F 3/067; G06F 3/065; G06F 3/0679

(57) ABSTRACT

A method of operating a host controlling a storage medium includes receiving initial authentication information; setting a portion of a storage space of the storage medium as a protection area; transmitting the received initial authentication information and protection area information with respect to the protection area to the storage medium; and discarding the initial authentication information in the host.

### CROSS-REFERENCE TO RELATED APPLICATIONS

This U.S. non-provisional patent application claims priority under 35 U.S.C. §119 to Korean Provisional Patent Application No. 10-2016-0079512, filed on Jun. 24, 2016 and Korean Patent Application No. 10-2016-0111902, filed on Aug. 31, 2016, the entire contents of each of which are hereby incorporated by reference.

### BACKGROUND

At least some example embodiments of the inventive concepts relate to semiconductor memories, and more particularly, to a method of operating storage medium, a method of operating the host controlling the storage medium, and a method of operating a user system including the storage medium and the host.

A semiconductor memory device is embodied using a semiconductor such as silicon (Si), germanium (Ge), gallium arsenide (GaAs), indium phosphide (InP), etc. A semiconductor memory device is classified as a volatile memory device or a nonvolatile memory device.

A flash memory which is one of nonvolatile memory devices is widely used as a high capacity storage medium for storing user data. Recently, malicious programs that threaten data stored in a high capacity storage medium are widely being spread. These malicious programs arbitrarily encrypt or modulate user data to prevent an actual user from using the user data. To protect user data from those malicious programs, various software or hardware data protection methods are being developed. However, conventional data protection methods have a problem that a malicious program modulates data through various alternate methods or additional costs are needed to protect the data.

### SUMMARY

According to at least some example embodiments of the inventive concepts, a method of operating a host controlling a storage medium includes receiving initial authentication information; setting a portion of a storage space of the storage medium as a protection area; transmitting the received initial authentication information and protection area information with respect to the protection area to the storage medium; and discarding the initial authentication information in the host.

According to at least some example embodiments of the inventive concepts, a method of operating a user system including a storage medium and a host that controls the storage medium includes receiving, by the host, initial authentication information; setting, by the host, a portion of a storage space of the storage medium as a protection area; transmitting, by the host, the received initial authentication information and protection area information with respect to the protection area to the storage medium; storing, by the storage medium, the received initial authentication information and the received protection area information in a nonvolatile memory included in the storage medium; and discarding, by the host, the initial authentication information in the host.

According to at least some example embodiments of the inventive concepts, a method of operating a storage medium includes receiving initial authentication information at the storage medium; storing the initial authentication information in the storage medium; setting a portion of a storage space of the storage medium as a protection area; receiving access authentication information and a data access request for accessing data stored in the protection area; and selectively processing the data access request based on the received access authentication information and the stored initial authentication information.

### BRIEF DESCRIPTION OF THE FIGURES

The above and other features and advantages of example embodiments of the inventive concepts will become more apparent by describing in detail example embodiments of the inventive concepts with reference to the attached drawings. The accompanying drawings are intended to depict example embodiments of the inventive concepts and should not be interpreted to limit the intended scope of the claims. The accompanying drawings are not to be considered as drawn to scale unless explicitly noted.

FIG. 1 is a block diagram illustrating a user system according to at least some example embodiments of the inventive concepts.

FIG. 2 is a view illustrating a software layer of a user system of FIG. 1.

FIG. 3 is a block diagram illustrating a memory controller of FIG. 1 in detail.

FIG. 4 is a flowchart illustrating a method of allocating or setting a protection area by a protection area manager of FIG. 1.

FIG. 5 is a view for explaining a method of allocating a protection area of FIG. 4.

FIG. 6 is a flowchart illustrating a method of processing an access request to a protection area of storage medium of FIG. 1.

FIG. 7 is a flowchart illustrating an embodiment for backing up a protection area of a user system of FIG. 1.

FIG. 8 is a flowchart illustrating another embodiment for backing up a protection area of a user system of FIG. 1.

FIG. 9 is a flowchart illustrating a method of synchronizing, by a host of FIG. 1, data in a protection area with data in a normal area.

FIG. 10 is a flowchart illustrating a method of initializing a protection area of a user system of FIG. 1.

FIG. 11 is a block diagram illustrating a user system according to at least some example embodiments of the inventive concepts.

FIG. 12 is a flowchart illustrating an operation of a host of FIG. 11.

FIG. 13 is a flowchart illustrating another operation of a host of FIG. 11.

FIG. 14 is a flowchart illustrating an operation of updating a free-boot manager.

FIG. 15 is a flowchart illustrating another method of allocating or setting a protection area by a protection area manager of FIG. 1.

FIG. 16 is a view for explaining a method of setting a protection area of FIG. 15.

FIG. 17 is a flowchart illustrating a write operation with respect to a host and a protection area of a storage medium of FIG. 1.

FIG. 18 is a flowchart illustrating a read operation with respect to a host and a protection area of a storage medium of FIG. 1.

FIG. 19 is a block diagram illustrating a solid state drive (SSD) system to which at least some example embodiments of the inventive concepts are applied.

### DETAILED DESCRIPTION OF THE EMBODIMENTS

As is traditional in the field of the inventive concepts, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the scope of the inventive concepts. Further, the blocks, units and/or modules of the embodiments may be physically combined into more complex blocks, units and/or modules without departing from the scope of the inventive concepts.

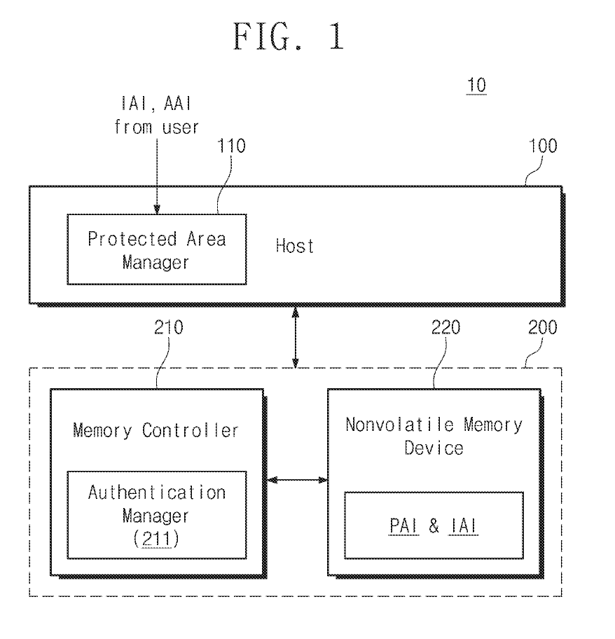

FIG. 1 is a block diagram illustrating a user system according to at least some example embodiments of the inventive concepts. Referring to FIG. 1, the user system 10 includes a host 100 and a storage medium 200. The user system 10 may include, for example, at least one of a computer, an Ultra Mobile PC (UMPC), a workstation, a net-book, a personal digital assistants (PDA), a portable computer, a web tablet, a tablet computer, a wireless phone, a mobile phone, a smart phone, a digital camera, a digital audio recorder, a digital audio player, a digital picture recorder, a digital picture player, a digital video recorder, a digital video player, a device that can transmit and receive information in a wireless environment, and various electronic devices constituting a home network.

According to at least some example embodiments of the inventive concepts, the host 100 may include a processor and drive an operating system (OS) and various application programs. The host 100 may write data in the storage medium 200, may read data written in the storage medium 200, or may change data written in the storage medium 200 in the process of driving the operating system and the various application programs

The storage medium 200 may be used as high-capacity storage medium of the user system 10. The storage medium 200 may be high capacity storage medium for storing user data, such as a solid state drive (SSD), a USB memory, a memory stick, a memory card, etc. The storage medium 200 may also be referred to, herein, as the storage device 200.

The storage medium 200 may include a memory controller 210 and a nonvolatile memory device 220. The memory controller 210 may write data in the nonvolatile memory device 220 or read data written in the nonvolatile memory device 220 to output the read data under the control of the host 100.

The nonvolatile memory device 220 may operate under the control of the memory controller 210. According to at least some example embodiments of the inventive concepts, the nonvolatile memory device 220 may include, for example, a volatile memory such as a SRAM (static RAM), a DRAM (dynamic RAM), a SDRAM (synchronous DRAM), etc. or a nonvolatile memory such as a ROM (read-only memory), a PROM (programmable ROM), an EPROM (electrically programmable ROM), an EEPROM (electrically erasable and programmable ROM), a flash memory, a PRAM (phase change RAM), a MRAM (magnetic RAM), a RRAM (resistive RAM), a FRAM (ferroelectric RAM), a TRAM (thyristor RAM), etc. The nonvolatile memory device 220 may include a plurality of memory dies, a plurality of memory chips, or a plurality of memory packages.

According to at least some example embodiments of the inventive concepts, the host 100 may include a protection area manager 110. The protection area manager 110 may be provided in the form of hardware, software (e.g., stored program instructions executed by a microprocessor), or combinations thereof. The protection area manager 110 may be a storage medium management program provided from a manufacturer or a vender of the storage medium 200 such that the host 100 may manage a function and performance of the storage medium 200.

The protection area manager 110 may set some portion of a storage space of the storage medium 200 as a protection area according to a request of a user. The protection area may indicate an area that is inaccessible by a request (esp., a write request) from an unauthenticated user or a malicious program.

For example, a storage space of the storage medium 200 may be freely accessed by various application programs. At this time, due to a malicious program such as ransomware, data stored in the storage space of the storage medium 200 may be accessed and the accessed data may be forged, modulated, or encrypted. To protect an access from a malicious program, the protection area manager 110 may set a part of a storage space of the storage medium 200 as the protection area.

The protection area manager 110 may copy, move, or back up data (hereinafter it is referred to as ‘protection data’) that needs a protection among data stored in the storage medium 200 to a protection area. Because an unauthenticated user and a malicious program cannot access the protection area, protection data stored in the protection area may be protected from (e.g., may not be modulated by) the malicious program.

According to at least some example embodiments of the inventive concepts, the protection area may be classified as a logical area. The protection area manager 110 may set the protection area as a read-only area. Alternatively, the protection area manager 110 may set data stored in the protection area as a read-only data. Other programs in the host 100 may not perform an access operation (e.g., a write operation) to the protection area by setting the protection area as a read-only area or setting data stored in the protection area as read-only data. Thus, since an access to the protection area from the host 100 is prevented, an incorrect operation due to an access to the protection area may be prevented.

According to at least some example embodiments of the inventive concepts, the protection area manager 110 may receive initial authentication information (IAI) from a user and may perform the protection area allocation operation described above in response to the received initial authentication information (IAI). The authentication information may indicate information such as a user password, a user biometrics, etc. After the authentication information is provided to the storage medium 200, the protection area manager 110 may discard the authentication information. That is, in a normal operation, user authentication information may not exist in the host 100.

According to at least some example embodiments of the inventive concepts, the protection area manager 110 may provide the received initial authentication information (IAI) and protection area information (PAI) about the allocated protection area to the storage medium 200. The protection area information (PAI) may include a start address or a range of a logical block address (LBA) of the protection area.

The storage medium 200 may store the initial authentication information (IAI) and the protection area information (PAI) received from the host 100, in particular, the protection area manager 110 in the nonvolatile memory device 220. According to at least some example embodiments of the inventive concepts, the received initial authentication information (IAI) and the protection area information (PAI) about the protection area may be stored in a meta area. The meta area may indicate a storage area for storing various information required when the storage medium 200 operates. The meta area may be a part of a storage space of the storage medium 200. The meta area may be a storage area being not identified by the host 100. According to at least some example embodiments of the inventive concepts, the storage medium 200 may be configured to store the initial authentication information (IAI) and the protection area information (PAI) in a separate storage area or a separate storage circuit. According to at least some example embodiments of the inventive concepts, the host 100 cannot recognize the initial authentication information (IAI) stored in the storage medium 200.

The memory controller 210 may include an authentication manager 211. The authentication manager 211 may perform an authentication operation with respect to a user. For example, the authentication manager 211 may identify or recognize a protection area in the storage area of the storage medium 200 based on the protection area information (PAT) stored in the nonvolatile memory device 220. In the case where an access request to a protection area is received from the host 100, the authentication manager 211 may perform an authentication operation based on the stored initial authentication information (IAI). In this case, the authentication operation may be performed by comparing access authentication information (AAI) provided from the host 100 with the initial authentication information (IAI) stored in the nonvolatile memory device 220.

For the convenience of description, authentication information provided from the host 100 at setting the protection area is called initial authentication information (IAI) and authentication information provided from the host 100 in an access operation is called access authentication information (AAI). The initial authentication information (IAI) is stored in the nonvolatile memory device 220 and the access authentication information (AAI) may be used to compare with the initial authentication information (IAI).

The protection area manager 110 of the host 100 may set a protection area as a read-only area or set data stored in the protection area as read-only data, thereby preventing an access to the protection area by other application programs. Thus, a normal operation of the host 100 is guaranteed and modulation, forging, and encryption of data due to a malicious program or an authenticated user may be prevented.

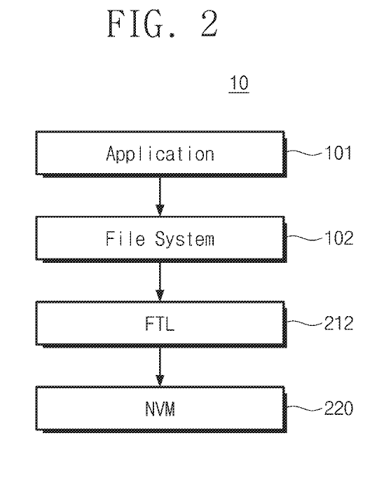

FIG. 2 is a view illustrating a software layer of a user system of FIG. 1. Referring to FIGS. 1 and 2, a software layer of the user system 10 may include an application 101, a file system 102, and a flash translation layer (FTL) 212. The application 101 and the file system 102 may be a software layer that is driven in the host 100.

The application 101 indicates various application programs that are driven in the host 100. The protection area manager 110 illustrated FIG. 1 may be provided in the form of software and may be an example of the application 101.

In the case where a file or data used by the application 101 is stored in the nonvolatile memory device 220, the file system 102 performs a function of organizing the file or the data. For example, the file system 102 may manage a storage area of the storage medium 220 by means of a logical address. The file system 102 may give a logical address to data stored in the storage medium 200 to manage the data using the logical address given to the data. The file system 102 may have a different form depending on an operating system (OS) of the host 100. The file system 102 may include FAT (file allocation table, FAT32, NTFS (NT file system), HFS (hierarchical file system), JSF2 (journaled file systerm2), XFS, ODS-5 (on-disk structure-5), UDF, ZFS, UFS (Unix file system), ext2, ext3, ext4, ReiserFS, Reiser4, ISO 9660, Gnome VFS, BFS, or WinFS.

The FTL 212 may provide an interface between the host 100 and the nonvolatile memory device 220 so that the nonvolatile memory device 220 is effectively used. For example, the FTL 212 may perform a translation operation that translates a logical address managed by the file system 102 to a physical address of the nonvolatile memory device 220. The FTL 212 manages the address translation operation through a mapping table. The mapping table may be stored in the meta area described with reference to FIG. 1. The FTL 212 may be driven in the memory controller 210. The authentication manager 211 of the memory controller 210 may be included in the FTL 212.

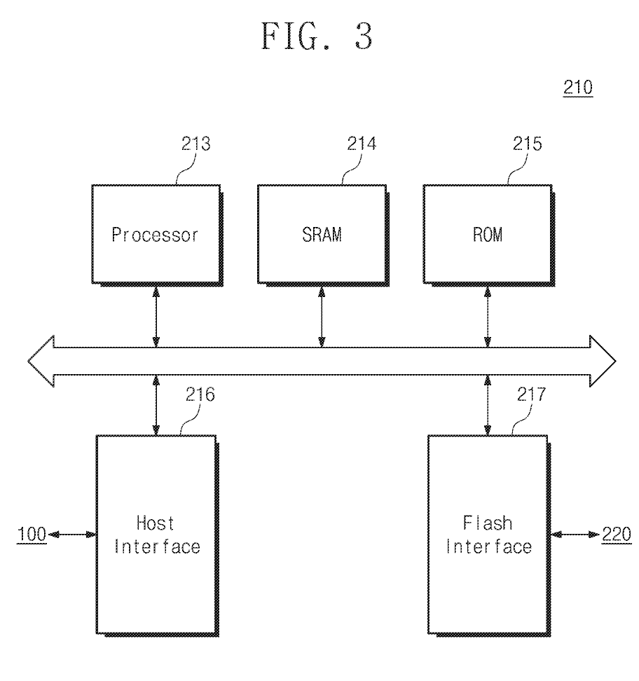

FIG. 3 is a block diagram illustrating a memory controller of FIG. 1 in detail. Referring to FIGS. 1 through 3, the memory controller 210 may include a processor 213, a SRAM 214, a ROM 215, a host interface 216, and a flash interface 217.

The processor 213 may control an overall operation of the memory controller 210. The SRAM 214 may be used as a buffer memory, a cache memory, or main memory of the memory controller 210. The ROM 215 may store various information required when the memory controller 210 operates in the form of firmware.

The memory controller 210 may communicate with the host 100 through the host interface 216. The host interface 216 may include at least one of various communication interfaces such as a DDR (double data rate) interface, a USB (universal serial bus) interface, a MMC (multimedia card) interface, an eMMC (embedded MMC) interface, a PCI (peripheral component interconnection) interface, a PCI-E (PCI-express) interface, an ATA (advanced technology attachment) interface, a serial-ATA interface, a parallel-ATA interface, a SCSI (small computer small interface) interface, an ESDI (enhanced small disk interface) interface, an IDE (integrated drive electronics) interface, a Firewire interface, a UFS (universal flash storage) interface, a NVM-e (nonvolatile memory express) interface, etc. The memory controller 210 may communicate with the nonvolatile memory device 220 through the flash interface 216.

According to at least some example embodiments of the inventive concepts, the authentication manager 211 and the FTL 212 described with reference to FIGS. 1 and 2 may be provided in the form of software, may be stored in the SRAM 214, and may be driven by the processor 213. According to at least some example embodiments of the inventive concepts, the authentication manager 211 may be included in one of various layers included in the host interface 216. The term ‘processor’, as used in the present disclosure, may refer to, for example, a hardware-implemented data processing device having circuitry that is physically structured to execute desired operations including, for example, operations represented as code and/or instructions included in a program. Examples of the above-referenced hardware-implemented data processing device include, but are not limited to, a microprocessor, a central processing unit (CPU), a processor core, a multi-core processor; a multiprocessor, an application-specific integrated circuit (ASIC), and a field programmable gate array (FPGA). Processors executing program code are programmed processors, and thus, are special-purpose computers.

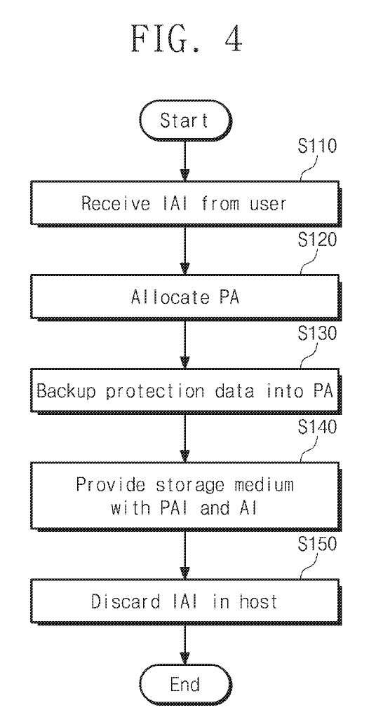

FIG. 4 is a flowchart illustrating a method of allocating or setting a protection area by a protection area manager of FIG. 1. Referring to FIGS. 1, 2, and 4, in an operation S110, the protection area manager 110 may receive initial authentication information (IAI) from a user. For example, the protection area manager 110 may receive initial authentication information (IAI) from a user through a separate input device (e.g., a keyboard, a touch screen, a biometric recognition device, etc.).

In an operation S120, the protection area manager 110 may allocate a protection area (PA). For example, the protection area manager 110 may allocate a part of a storage space of the storage medium 200 as the protection area (PA). According to at least some example embodiments of the inventive concepts, the allocated protection area (PA) may be a storage space having a size determined by a request of a user. The allocated protection area (PA) may be a storage space having a predetermined or, alternatively, desired size. The allocated protection area (PA) may have a successive logical block address (LBA). The allocated protection area (PA) may have a predetermined or, alternatively, desired successive logical block address (LBA).

In an operation S130, the protection area manager 110 may backup protection data to the allocated protection area (PA). For example, a user may select protection data that needs to be protected among data stored in the storage medium 200. The protection area manager 110 may back up protection data selected by the user to the allocated protection area (PA). In the description that follows, for brevity of description, an operation of moving, copying, updating or deleting data is called a back-up operation.

In an operation S140, the protection area manager 110 may provide the protection area information (PAI) and the initial authentication information (IAI) to the storage medium 200. The storage medium 200 may store the received protection area information (PAI) and the initial authentication information (IAI) in a meta area (or a separate storage area). Thereafter, in the case where an access request corresponding to the protection area information (PAI) is received, the storage medium 200 may process or reject the access request by performing a separate authentication operation.

In an operation S150, the protection area manager 110 may discard the initial authentication information (IAI) in the host 100. For example, the initial authentication information (IAI) may be temporarily stored in a main memory or a separate storage device (not illustrated) of the host 100 to be transmitted to the storage medium 200. After completing the operation of S140, the host 100 may discard, remove, or delete the initial authentication information (IAI) stored in the main memory or the separate storage device. Since the initial authentication information (IAI) is discarded in the host 100, an operating system or other applications in the host 100 cannot recognize or identify initial authentication information (IAI). Even though the initial authentication information (IAI) is discarded by the host 100, the initial authentication information (IAI) in the storage medium 200 may be maintained.

According to at least some example embodiments of the inventive concepts, the protection area manager 110 may set the protection area (PA) as a read-only, after performing the operation of S130. For example, the protection area manager 110 may designate the protection area (PA) as a separate partition. The protection area manager 110 may set a property (e.g., permissions or access rights) of the designated partition as a read-only.

Alternatively, the protection area manager 110 may set a property (e.g., permissions or access rights) of data stored in the protection area (PA) as a read-only, after performing the operation of S130.

Alternatively, the protection area manager 110 may perform a defective sector check. During the defective sector check, the storage medium 200 may cause a defective sector so that the host 100 recognizes the storage space allocated as the protection area (PA) as the defective sector. In this case, the host 100 may recognize the protection area (PA) as an area including the defective sector and may not perform an access to the protection area (PA).

As described above, other applications or an operating system (OS) in the host 100 may be prevented from accessing the protection area (PA) by setting the protection area (PA) as a read-only or using the defective sector.

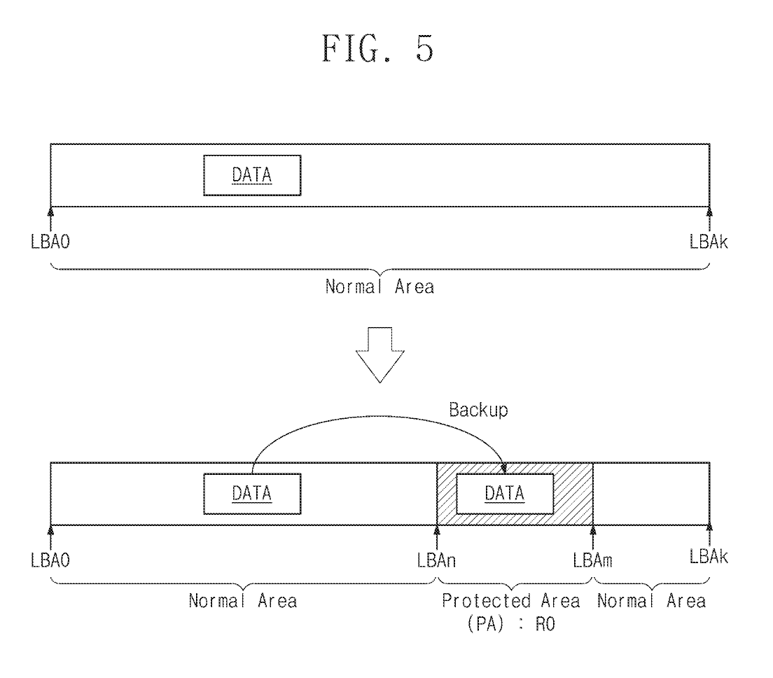

FIG. 5 is a view for explaining a method of allocating a protection area of FIG. 4. Referring to FIGS. 1, 2, 4 and 5, the host 100 (esp., the file system 102) may recognize a storage space of the storage medium 200 as a space of logical block addresses (LBA0 to LBAk). The storage space recognized by the host 100 may be a normal area that may be freely accessed by the application 101. It is assumed that data (e.g., user data) is stored in a space of the logical block addresses (LBA 0 to LBAk). The space of the logical block addresses (LBA0 to LBAk) recognized by the host 100 may be different from an actual physical storage space of the storage medium 200. The logical block addresses (LBA0 to LBAk) may be translated into a physical address of the nonvolatile memory device 220 by the FTL 212.

The protection area manager 110 of the host 100 may set a part of the normal area as the protection area (PA) according to a request of a user. For example, the protection area manager 110 divides a part of the normal area into a separate partition and may set the divided partition as the protection area (PA), as illustrated in FIG. 5. In this case, the file system 102 of the host 100 may recognize the storage space by two (2) partitions. Each of the two partitions indicates a partition (a space of LBA0 to LBAn and LBAm to LBAk) with respect to the normal area and a partition (a space of LBAn to LBAm) with respect to the protection area (PA). According to at least some example embodiments of the inventive concepts, the protection area manager 110 may perform the partition division operation using a partition division function provided from the operating system (OS).

After designating the protection area (PA) through the partition division operation, the protection area manager 110 may back up data (i.e., protection data) to the protection area (PA) or to the divided partition. After that, the protection area manager 110 may set a property (e.g., permissions or access rights) of the partition corresponding to the protection area (PA) as a read-only (RO). That is, other applications or an operating system (OS) may be prevented from accessing, in particular writing the protection area (PA) by setting a property (e.g., permissions or access rights) of the partition corresponding to the protection area (PA) as a read-only (RO). Accordingly, an incorrect operation of the user system 10 may be prevented.

According to at least some example embodiments of the inventive concepts, the protection area manager 110 may provide protection area information (PAI) with respect to the protection area (PA) and initial protection information (IAI) to the storage medium 200 and the storage medium 200 may manage an access to the protection area (PA) based on the received information. In the case where there is not a separate authentication, the storage medium 200 does not process an access to the protection area (PA) and thus data stored in the protection area (PA) may be protected from other application, in particular a malicious program.

The method of setting the protection area (PA) described with reference to FIG. 5 is illustrative and at least some example embodiments of the inventive concepts are not limited thereto. By changing a property (e.g., permissions or access rights) of data stored in the protection area (PA) or using a defective sector check method as described with reference to FIG. 4, the host 100 may prevent for other applications or an operating system (OS) to access the protection area (PA). However, at least some example embodiments of the inventive concepts are not limited thereto. For example, the host 100 may prevent for other applications or an operating system (OS) to access the protection area (PA) through various methods not written herein.

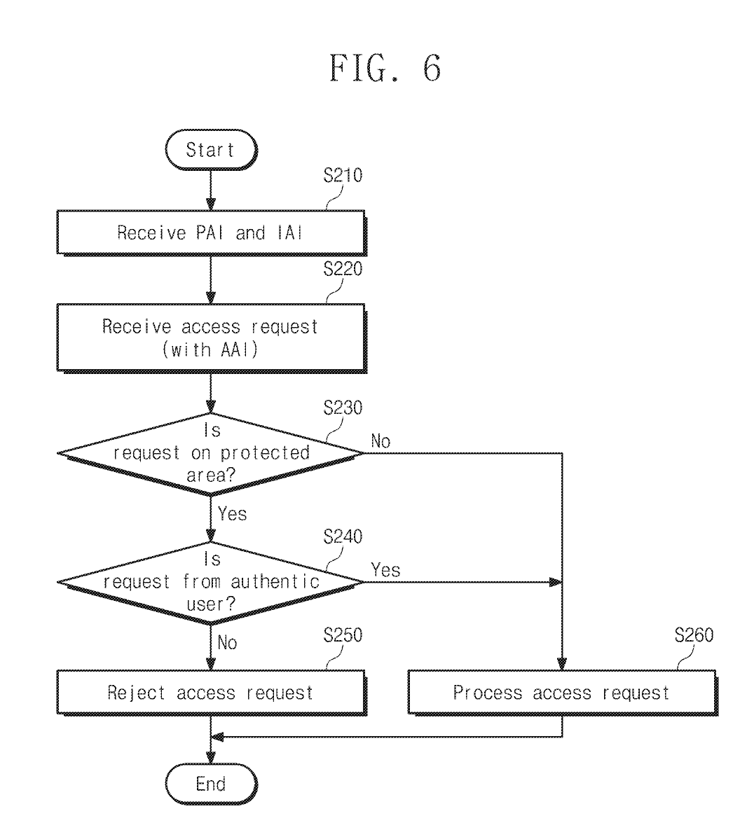

FIG. 6 is a flowchart illustrating a method of processing an access request to a protection area of storage medium of FIG. 1. For convenience of description, from the viewpoint of the storage medium 200, a method of processing an access request is described. The method of FIG. 6 may be performed by the authentication manager 211 of the storage medium 200.

Referring to FIGS. 1 and 6, in an operation S210, the storage medium 200 may receive protection area information (PAI) and initial authentication information (IAI) from the host 100. The received protection area information (PAI) and the received initial authentication information (IAI) may be stored in a separate storage area or a meta area of the nonvolatile memory device 220.

In an operation S220, the storage medium 200 may receive an access request. The access request may be a write request from the host 100. The access request from the host 100 may be received together with access authentication information (AAI) or include the access authentication information (AAI). The access authentication information (AAI) may be information received from a user, when the user requests an access to the protection area (PA). The host 100 may require or receive the access authentication information (AAI) from a user before issuing an access request.

In an operation S230, the storage medium 200 may determine whether the received access request is a request with respect to the protection area (PA). For example, the storage medium 200 may recognize a logical block addresses set as the protection area (PA) based on the protection area information (PAI) received in the operation S210. The storage medium 200 may determine whether a logical block address with respect to the received access request is included in the logical block addresses set as the protection area (PA).

In a case of an access request for accessing the protection area (PA), in an operation S240, the storage medium 200 may determine whether the access request is an access request from an authenticated user. For example, the storage medium 200 may perform an authentication operation based on the access authentication information (AAI) received in the operation S220. The storage medium 200 may receive the access authentication information (AAI) together with an access request from the host 100 as described at the operation S220. The storage medium 200 may determine whether the received access request is a request from the authenticated user by comparing the stored initial authentication information (IAI) with the access authentication information (AAI).

Alternatively, in the case where the access request for accessing the protection area (PA) from the host 100 and the access authentication information (AAI) are not received together (i.e., only the access request for accessing the protection area (PA) from the host 100 is received), the storage medium 200 may determine that the received access request is a request from an unauthenticated user.

In the case where the received access request for accessing the protection area (PA) is not an access request from an authenticated user, in an operation S250, the storage medium 200 may reject the access request. For example, the storage medium 200 may not perform a separate operation with respect to the received access request. The storage medium 200 may provide a separate response or an interrupt signal to the host 100 with respect to the received access request.

The host 100 can recognize that an unauthenticated user or an unauthenticated application (e.g., a malicious program) attempts an access to the protection area (PA) in response to a non-response, a separate response, or an interrupt signal from the storage medium 200. Through a separate medium (e.g., a display, a speaker, etc.), the host 100 may notify a user that the unauthenticated user or the unauthenticated application attempts an access to the protection area (PA). The user may perform a separate security operation (e.g., an error test, a virus test, etc.) through the notification to remove a malicious program.

In the case where the received access request is not an access to the protection area (PA) or is a request from an authenticated user, in an operation S260, the storage medium 200 may process the received access request.

According to at least some example embodiments of the inventive concepts, the unauthenticated user or the unauthenticated application may change a property (e.g., permissions or access rights) of the protection area (PA) set as a read-only (RO) to transmit an access request to the protection area (PA). However, as described above, the storage medium 200 may perform a separate authentication operation with respect to the access request to the protection area (PA) and may process the access request to the protection area (PA) only when the access request is authenticated. Thus, an access to the protection area (PA) of the unauthenticated user or the unauthenticated application may be prevented and data stored in the protection area (PA) may be safely protected.

There may be various methods for backing up, updating, deleting, or copying protection data stored in the protection area (PA) by an authenticated user. Various operations for backing-up protection data of the host 100 and the storage medium 200 in accordance with at least some example embodiments of the inventive concepts are discussed in greater detail below. However, embodiments that will be described below are examples and the scopes of at least some example embodiments of the inventive concepts are not limited thereto.

It is assumed that the host 100 sets the protection area (PA) among storage spaces of the storage medium 200 through the protection area setting method described with reference to FIGS. 4 and 5. It is also assumed that the storage medium 200 receives the protection area information (PAI) and the initial authentication information (IAI) from the host 100 and stores the received information in a separate storage circuit or a meta area of the nonvolatile memory device 220.

For brevity of description, operation methods are described from the viewpoint of the host 100 and the storage medium 200 but the operations below may be performed by the protection area manager 110 of the host 100 and the memory controller 210 of the storage medium 200.

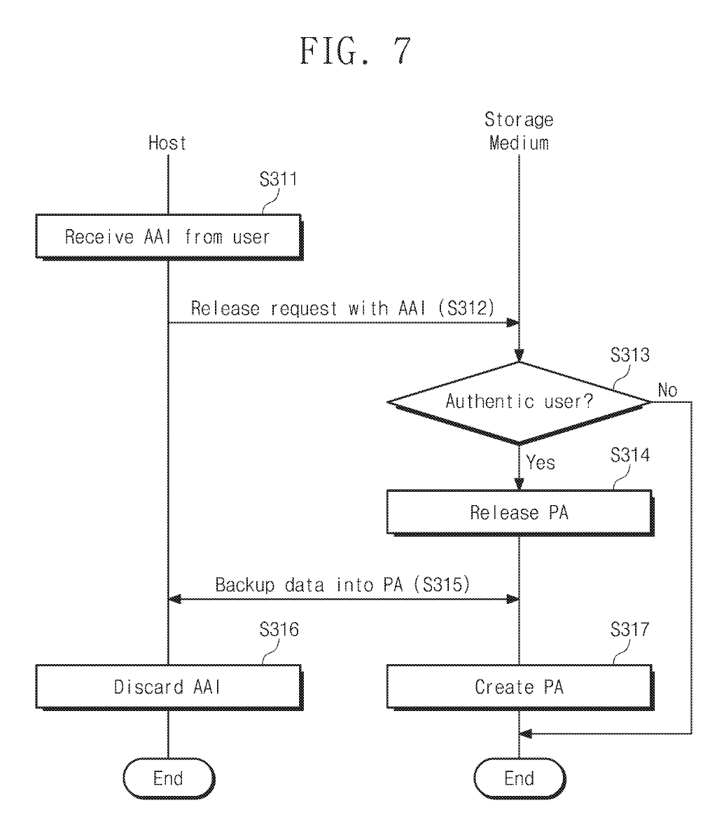

FIG. 7 is a flowchart illustrating an embodiment for backing up a protection area of a user system of FIG. 1. Referring to FIGS. 1 and 7, in an operation S311, the host 100 may receive access authentication information (AAI) from a user. For example, the host 100 may receive the access authentication information (AAI) from a user through a separate input device (e.g., keyboard, touch screen, biometric recognition device, etc.). According to at least some example embodiments of the inventive concepts, the operation S311 may be performed by an explicit request from a user.

In an operation S312, the host 100 may transmit a release request for releasing the protection area (PA) to the storage medium 200 together with the access authentication information (AAI). The host 100 may communicate with the storage medium 200 based on a predetermined or, alternatively, desired protocol and the access authentication information (AAI) and the release request may be provided to the storage medium 200 according to the method based on the predetermined or, alternatively, desired protocol. According to at least some example embodiments of the inventive concepts, the access authentication information (AAI) may be included in the release request.

In an operation S313, the storage medium 200 may determine whether the received release request is a request from an authenticated user. For example, the storage medium 200 may determine whether the received release request is a request from an authenticated user by comparing the stored initial authentication information (IAI) with the received access authentication information (AAI).

In the case where the received release request is a request from an authenticated user, the storage medium 200 may release the protection area (PA) in an operation S314. According to at least some example embodiments of the inventive concepts, releasing the protection area (PA) may mean that an access request with respect to the protection area can be processed without a separate authentication operation. Alternatively, releasing the protection area (PA) may also mean that a protection area is changed to a normal area (e.g., changed from a read-only/defective area to an area in which data may be written).

In an operation S315, the host 100 and the storage medium 200 may back up data to the protection area (PA). For example, the host 100 may read protection data stored in the normal area and back up the read data to the protection area (PA), based on the predetermined or, alternatively, desired protocol.

For brevity of drawing, in the operation S315, a data backup process is illustrated through one operation step but the host 100 and the storage medium 200 may exchange various signals with each other during the data backup operation. The various signals may be signals based on the predetermined or, alternatively, desired protocol.

After the data backup operation is completed, in an operation S316, the host 100 may discard the access authentication information (AAI). For example, the access authentication information (AAI) received in the operation S311 may be temporarily stored in a main memory (not illustrated) of the host 100 to be transmitted to the storage medium 200. After completing the data backup operation, the host 100 may discard, remove, or delete the access authentication information (AAI) stored in the main memory. Since the access authentication information (AAI) is discarded in the host 100, an operating system (OS) or other applications cannot recognize or identify the access authentication information (AAI). Even though the access authentication information (AAI) is discarded by the host 100, the initial authentication information (IAI) stored in the storage medium 200 may be maintained.

After the data backup operation is completed, in an operation S317, the storage medium 200 may reset the protection area (PA). Resetting, by the storage medium 200, the protection area (PA) may mean that an authentication operation is performed with respect to an access request to the protection area (PA).

The host 100 may transmit the protection area information (PAI) to the storage medium 200 to reset the protection area (PA), and the storage medium 200 may reset the protection area (PA) based on the received protection area information (PAI). According to at least some example embodiments of the inventive concepts, resetting the protection area (PA) may refer to changing the location (or, logical addresses) of the protection area within the storage medium 200 and moving the data that has already been backed-up in the old protection area to the new, reset protection area (PA). Alternatively, resetting the protection area (PA) may refer to changing a state of the protection area (PA) from writable back to read-only (or, from non-defective back to defective).

As described above, the host 100 and the storage medium 200 may temporarily release the protection area (PA) based on the access authentication information (AAI) from a user to perform a data backup to the protection area (PA) and then may reset the protection area (PA). An update, write, or delete of data with respect to the protection area (PA) is possible through the operation described above.

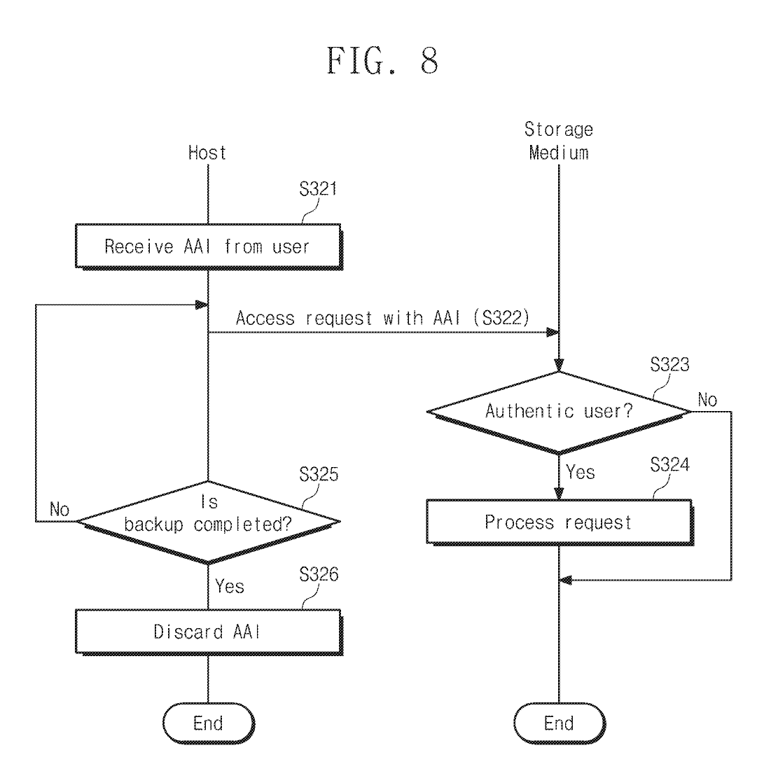

FIG. 8 is a flowchart illustrating another embodiment for backing up a protection area of a user system of FIG. 1. Referring to FIGS. 1 and 8, the host 100 performs an operation of S321. The operation of S321 may be similar to the operation of S311 of FIG. 7.

In an operation S322, the host 100 may transmit access authentication information (AAI) and an access request for accessing a protection area (PA) to the storage medium 200. The access authentication information (AAI) and the access request may be signals based on a predetermined or, alternatively, desired protocol.

In an operation S323, the storage medium 200 may determine whether the received access request is a request from an authenticated user. Since an operation of S323 is similar to the operation of S313, a detailed description thereof is omitted.

In the case where the received access request is a request from an authenticated user, in an operation S324, the storage medium 200 may process the received access request. For example, in the case where the received access request indicates an update of data stored in the protection area (PA), the storage medium 200 may update the data stored in the protection area (PA). That is, the storage medium 200 may perform an operation corresponding to the received access request.

In the case where the received access request is not a request from an authenticated user, the storage medium 200 may not perform a separate operation. Although not illustrated in the drawing, the storage medium 200 may provide a specific notification signal to the host 100. The specific notification signal may be a signal for notifying that an access requested is refused.

In an operation S325, the host 100 may determine whether a data backup is completed. The host 100 may determine whether protection data according to a request of a user is all backed up to the protection area (PA).

In the case where the data backup is not completed, the host 100 performs the operation of S322. In the case where the data backup is completed, in an operation S326, the host 100 may discard the access authentication information (AAI). Since the operation of S326 is similar to the operation of S316 of FIG. 7, a detailed description thereof is omitted.

As described above, the host 100 may receive single access authentication information (AAI) from a user and may perform a backup operation with respect to a plurality of protection data using the received access authentication information (AAI). At this time, the host 100 transmits the access authentication information (AAI) to the storage medium 200 together with a request for a backup. The storage medium 200 performs an authentication operation by comparing the received access authentication information (AAI) with the initial authentication information (IAI) stored in advance and only in the case where the authentication operation is completed, performs an operation (e.g., a backup or update operation of protection data) corresponding to the received request.

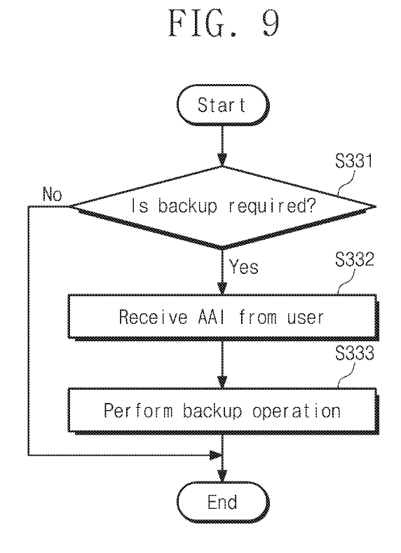

FIG. 9 is a flowchart illustrating a method of synchronizing, by a host of FIG. 1, data in a protection area with data in a normal area. For brevity of drawing and convenience of description, the method of synchronizing data is described from the viewpoint of the host 100.

Referring to FIGS. 1 and 9, in an operation S331, the host 100 may determine whether a data backup is required. For example, the host 100 may monitor protection data stored in the normal area and may determine whether a backup of the protection data is required. The operation of S331 may be automatically performed by the protection area manager 110 or may be performed by an explicit request from a user.

In the case where a backup of the protection data is required, in an operation S332, the host 100 may receive access authentication information (AAI) from a user. For example, in the case where a backup of the protection data is required, the protection area manager 110 of the host 100 may request a user for the access authentication information (AAI) through separate medium (e.g., a display, a speaker, etc.). The user may provide the access authentication information (AAI) to the host 100 for a backup of the protection data according to an access authentication information (AAI) request.

In an operation S333, the host 100 may perform a backup operation based on the received access authentication information (AAI). The operations of S332 and S333 may be performed through the backup method described with reference to FIGS. 7 and 8.

As described above, the protection area manager 110 of the host 100 may determine whether a backup of the protection data is required and may perform the backup according to a determination result or a request of a user. The storage medium 200 may perform an authentication operation based on the access authentication information (AAI) from a user and may perform a backup of the protection data according to a result of the authentication operation. Thus, data of the protection area (PA) may be protected from an unauthenticated user or application.

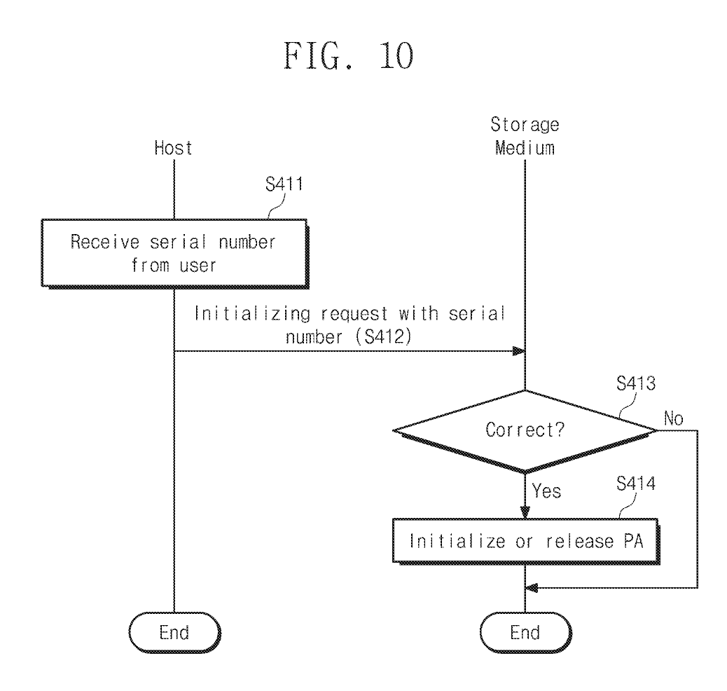

FIG. 10 is a flowchart illustrating a method of initializing a protection area of a user system of FIG. 1. In the case where a user loses authentication information or cannot normally input authentication information, the protection area (PA) may be released or initialized according to a method illustrated in FIG. 10.

Referring to FIGS. 1 and 10, the host 100, in an operation S411, may receive a serial number from a user. The serial number may be a code of a combination of predetermined or, alternatively, desired characters or numbers which is different from the initial authentication information or the access authentication information. The serial number may be a physical security ID (PSID) provided by a manufacturer or vender of storage medium 200.

In an operation S412, the host 100 may provide an initialization request and the serial number to the storage medium 200. The initialization request and the serial number may be a signal based on a predetermined or, alternatively, desired protocol.

In an operation S413, the storage medium 200 may determine whether the received serial number is correct in response to the received initialization request. The storage number 200 may store information about the serial number in a separate storage circuit (e.g., ROM) in advance. The information about the serial number may be stored in the process of manufacturing the storage medium 200. The storage medium 200 may determine whether the received serial number is correct by comparing the received serial number with the serial number stored in advance.

In the case where the serial number is correct, in an operation S414, the storage medium 200 may initialize or release the protection area (PA). The operation of S414 may be similar to the operation of S314 in FIG. 7. In the case where the serial number is not correct, the storage medium 200 may not perform a specific operation.

As described above, in the case where a user loses authentication information, the host 100 may release the protection area (PA) using a separate serial number from the user. According to at least some example embodiments of the inventive concepts, after the protection area (PA) is released, the host 100 may reset the protection area (PA) by performing the operation method described with reference to FIGS. 4 and 5.

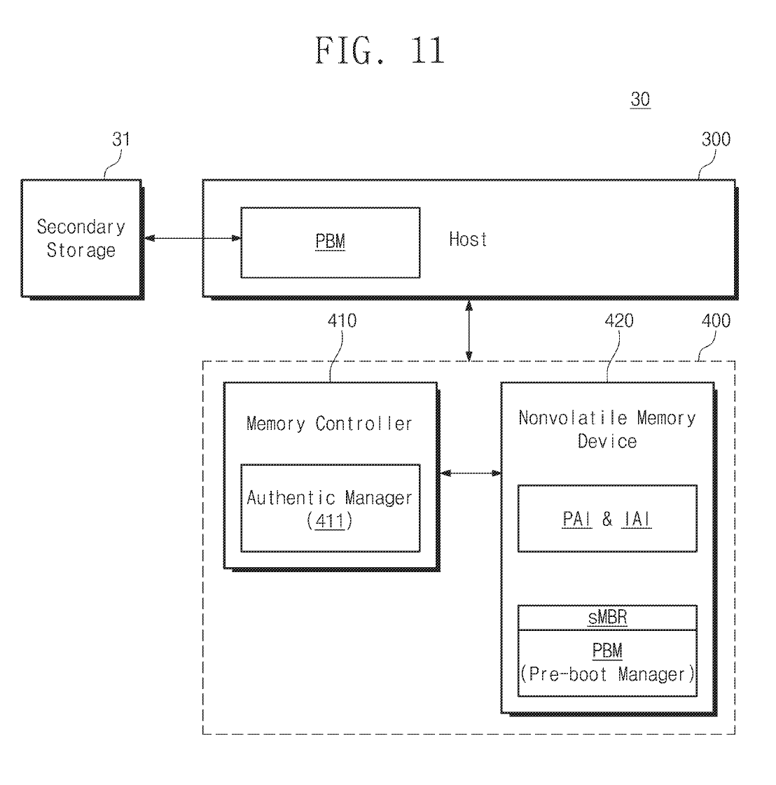

FIG. 11 is a block diagram illustrating a user system according to at least some example embodiments of the inventive concepts. A method and a system of managing the protection area (PA) are described with reference to FIG. 11 in the case where the host 100 cannot normally drive an operating system.

Referring to FIG. 11, the user system 30 may include a host 300 and storage medium 400. The storage medium 400 may include a memory controller 410 and a nonvolatile memory device 420. The memory controller 410 may include an authentication manager 411. The nonvolatile memory device 420 may store protection area information (PAI) and initial authentication information (IAI). According to at least some example embodiments of the inventive concepts, the memory controller 410 may have the structure illustrated in FIG. 3.

An operating system of the host 300 may not normally operate. In this case, the host 300 may include a processor and may drive a pre-boot manager (PBM) by executing a shadow master boot record (sMBR) of the storage medium 400 according to an explicit request from a user.

For example, in a normal booting operation of the user system 30, the host 300 loads a master-boot record of the storage medium 400 and the host 300 recognizes a storage area of the storage medium 400 based on the master-boot record. After that, the host 300 drives an operating system according to an established procedure based on the recognized storage area.

The host 300 may load the shadow master boot record (sMBR) according to, for example, an explicit request of a user before the master-boot record is loaded. The storage area recognized by the shadow master boot record (sMBR) may store a program code or information about the pre-boot manager (PBM). The host 300 may drive the pre-boot manager (PBM) by executing the shadow master boot record (sMBR). In a normal booting operation (i.e., in the case where a master boot record is executed instead of the shadow master boot record (sMBR)), the host 300 cannot recognize the shadow master boot record (sMBR).

The pre-boot manager (PBM) may be configured to perform an operation of the protection area manager 110 described with reference to FIGS. 1 through 10. That is, the pre-boot manager (PBM) may be configured to perform operations such as a protection area setting, a protection data backup, a protection area release, etc.

The pre-boot manager (PBM) may be configured to recognize a secondary storage 31 through an external communication interface such as USB, e-SATA, UFS, eMMC, etc. The secondary storage 31 may be high-capacity storage medium such as a USB memory stick, a memory card, an outer-mounted SSD, etc.

The pre-boot manager (PBM) may read protection area information (PAI) stored in a meta area and may recognize a protection area (PA) based on the read protection area information (PAI). The memory controller 410 may store a start LBA of an area in which a boot record about the protection area (PA) is stored in a separate area (e.g., a meta area) and the pre-boot manager (PBM) may recognize the protection area (PA) by executing the boot record about the protection area (PA) with reference to the start LBA stored in the separate area. The operation of storing the start LBA of the area in which the boot record in the separate area (e.g., meta area) may be executed by a memory controller during an operation of setting the protection area (PA) described with reference to FIGS. 4 and 5. The boot record may be configured to include the protection area information (PAI) about the protection area (PA).

The pre-boot manager (PBM) may be configured to recognize the protection area (PA) and to back up the data stored in the protection area (PA) to the secondary storage 31. And then, the pre-boot manager (PBM) may be configured to reset the protection area (PA) according to a request of a user.

As described above, in the case where an operating system of the host 300 does not normally operate, the host 300 may execute the pre-boot manager (PBM) stored in a specific area (e.g., an area recognized by the shadow master boot record (sMBR)) of the storage medium 400. The pre-boot manager (PBM) may perform operations such as a protection area setting, a data backup of the protection area, a protection area resetting, etc.

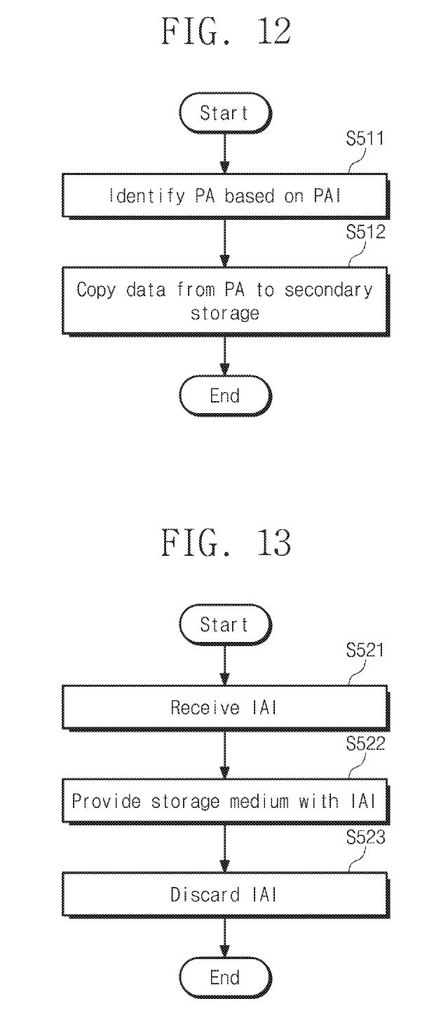

FIG. 12 is a flowchart illustrating an operation of a host of FIG. 11. For convenience of description, it is assumed that the host 300 is driving the pre-boot manager (PBM) identified by the shadow master boot record (sMBR). An operation method of FIG. 12 is described from the viewpoint of the host 300. However, the operation of FIG. 12 may be performed by the pre-boot manager (PBM) which is being driven in the host 300.

Referring to FIGS. 11 and 12, in an operation S511, the host 300 may identify the protection area (PA) based on the protection area information (PAI). As described above, the memory controller 410 may store the protection area information (PAI) in the meta area. The memory controller 410 may store a start LBA value of the boot record including the protection area information (PAI) in the meta area. The host 300 may identify the protection area (PA) based on the information stored in the meta area.

In an operation S512, the host 300 may copy data from the protection area (PA) to the secondary storage 31. For example, the pre-boot manager (PBM) which is being driven in the host 300 may be configured to recognize the secondary storage 31 connected to the host 300. The pre-boot manager (PBM) may be configured to back up the data of the protection area (PA) to the recognized secondary storage 31.

As described above, in the case where an operating system of the host 300 does not normally operate, the host 300 may drive the pre-boot manager (PBM) according to an explicit request of a user. The pre-boot manager (PBM) may protect data stored in the protection area (PA) by copying or backing up the data stored in the protection area (PA) to the separate secondary storage 31.

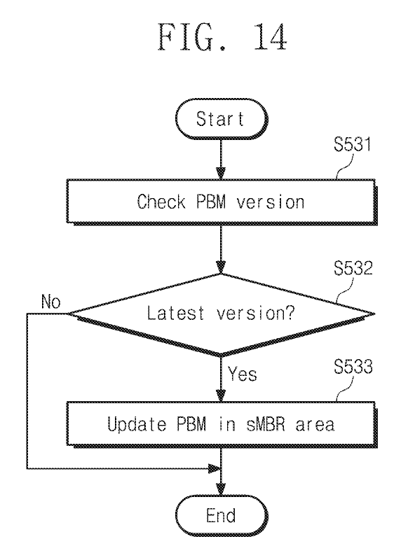

FIG. 13 is a flowchart illustrating another operation of a host of FIG. 11. An operation method of FIG. 13, in common with FIG. 12, is described from the viewpoint of the host 300 but may be performed by the pre-boot manager (PBM) which is being driven in the host 300.

Referring to FIGS. 11 and 13, in an operation S521, the host 300 may receive the initial authentication information (IAI). For example, the pre-boot manager 310 of the host 300 may receive initial authentication information (IAI) from a user to reset the initial authentication information (IAI) stored in the storage medium 400. The received initial authentication information (IAI) is information for resetting the initial authentication information (IAI) stored in the storage medium 400 and may be different from the initial authentication information (IAI) stored in the storage medium 400. The initial authentication information (IAI) received in the operation of S512 is called reset initial authentication information.

In an operation S522, the host 300 may provide the storage medium 400 with the reset initial authentication information. For example, the storage medium 400 may reset the initial authentication information based on the received reset initial authentication information (IAI). After resetting the initial authentication information, the storage medium 400 may perform an authentication operation based on the reset initial authentication information (IAI).

In an operation S523, the host 300 may discard the reset initial authentication information (IAI). For example, after a reset of the initial authentication information (IAI) is completed, the host 300 may discard the reset initial authentication information (IAI). That is, the initial authentication information (IAI) may not be stored in the host 300.

The backup operation and the authentication information reset operation of the pre-boot manager (PBM) of the host 300 may be performed without a separate authentication operation in the storage medium 400. Since the pre-boot manager (PBM) may be a program driven in an area by the shadow master boot record (sMBR), the pre-boot manager (PBM) may be a program separated from other unauthenticated user or a malicious program. Thus, since an operation of the pre-boot manager (PBM) is guaranteed to be an operation of an authenticated user, a separate authentication operation in the storage medium 400 may be omitted.

FIG. 14 is a flowchart illustrating an operation of updating a free-boot manager. An operation of FIG. 14 may be performed by the protection area manager 110 illustrated in FIG. 1. An update operation of the protection area manager 110 may be performed while the host 100 drives a normal operating system.

Referring to FIGS. 1, 11 and 14, in an operation S531, the protection area manager 110 may check a version of the pre-boot manager (PBM). For example, the protection area manager 110 may check a version of the pre-boot manager (PBM) stored in the storage medium 400 using a reserve command, a vender command, or a combination of separate commands.

In an operation S532, the protection area manager 110 may determine whether a version of the pre-boot manager (PBM) is the latest version. For example, the protection area manager 110 may check the latest version of the pre-boot manager (PBM) provided from an external server (e.g., a server provided by a manufacturer of the storage medium 200) through a wireless or wired network. The protection area manager 110 may determine whether a version of the pre-boot manager (PBM) is the checked latest version.

In the case where a version of the pre-boot manager (PBM) is not the latest version, in an operation S533, the protection area manager 110 may update the pre-boot manager (PBM) stored in an area of the shadow master boot record (sMBR) to the latest version. For example, the protection area manager 110 may download the latest version of the pre-boot manager (PBM) from the external server through the wireless or wired network. The protection area manager 110 may receive the latest version of the pre-boot manager (PBM) from a separate secondary storage (e.g., a USB memory, a memory card, a memory stick, etc.). The protection area manager 110 may update the pre-boot manager (PBM) using various methods for updating the shadow master boot record (sMBR). The protection area manager 110 may update the pre-boot manager (PBM) using a reserve command, a manufacturer command, or a combination of separate commands.

According to at least some example embodiments of the inventive concepts, the update operation of the pre-boot manager (PBM) may be performed according to a result of an additional authentication operation (i.e., the authentication operation described with reference to FIGS. 1 through 10) in the storage medium 200 or 400. That is, the update operation of the pre-boot manager (PBM) may be performed only when a user is determined to be an authenticated user. According to at least some example embodiments of the inventive concepts, the update operation of the pre-boot manager (PBM) may be performed without a separate authentication operation.

According to at least some example embodiments of the inventive concepts described above, the host may set a part of a storage area of the storage medium. The host may prevent an access to the protection area, (e.g., by preventing performance of a write operation on the protection area) by other applications or other operating systems by setting the set protection area as a read-only area.

Additionally, the storage medium performs a separate authentication operation with respect to an access to the protection area based on the protection area information (PAI) and the initial authentication information (IAI) provided from the host. Accordingly, an access to the protection area by an unauthenticated user and a malicious program may be prevented. That is, security of data stored in the storage medium is maintained by an authentication operation of the storage medium and an abnormal operation in the host may be prevented by setting a method for setting a protection area of the of the host. Thus, storage medium and a host improve.

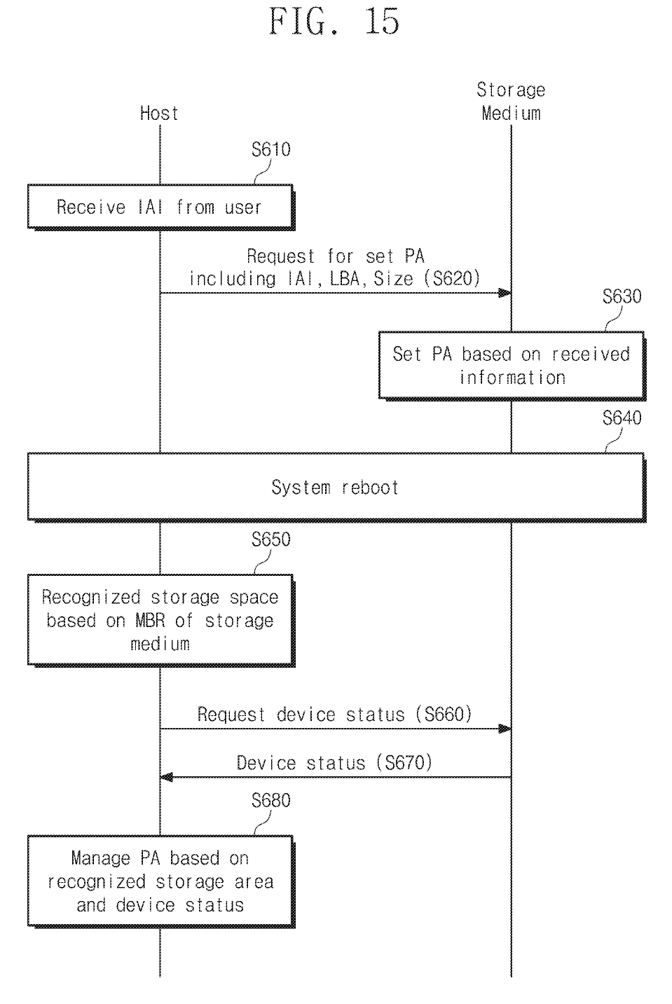

FIG. 15 is a flowchart illustrating another method of allocating or setting a protection area by a protection area manager of FIG. 1. For brevity of drawing and convenience of description, an operation of FIG. 15 is described based on the host 100 and the storage medium 200 in FIG. 1. However, scopes of at least some example embodiments of the inventive concepts are not limited thereto and an operation of the host 100 may be performed by the protection area manager 110 of the host 100 and an operation of the storage medium 200 may be performed by the authentication manager 211 of the storage medium 200.

According to at least some example embodiments of the inventive concepts, information or a signal exchanged between the host 100 and the storage medium 200 may be based on a specific interface between the host 100 and the storage medium 200. Information included in the information or the signal exchanged between the host 100 and the storage medium 200 may be included in a reserve area or a reserve field of information or signals defined by the specific interface. An exchange of a signal or information which is described below may be performed without a change of a separate interface.

Referring to FIGS. 1 and 15, in an operation S610, the host 100 may receive the initial authentication information (IAI) from a user. Since an operation of S610 is similar to the operation of S110 of FIG. 4, a detailed description thereof is omitted.

In an operation S620, the host 100 may transmit a request for setting the protection area (PA) to the storage medium 200. The request for setting the protection area (PA) may include the initial authentication information (IAI), a logical block address (LBA) with respect to the protection area (PA), and size information.

In an operation S630, the storage medium 200 may set the protection area (PA) in response to the received request. For example, the protection area (PA) setting method described with reference to FIGS. 4 and 5 may be performed in a layer of the file system 102 of the host 100. That is, the set protection area (PA) may be a storage space recognized by the host 100.

On the contrary, according to the embodiment of FIG. 15, the host 100 may provide a protection area (PA) setting request including the logical block address (LBA) with respect to the protection area (PA) and the size information to the storage medium 200 and the storage medium 200 may set the protection area (PA) in response to the received request. The protection area (PA) may be set as an area (i.e., a hidden area) which is not identified by the host 100.

As more specifically examples, it is assumed that a storage space of the storage medium 200 that may be recognized as a normal area by the host 100 is 120 GB. The storage medium 200 may reduce the storage space that may be recognized as a normal area by the host 100 from 120 GB to 100 GB. The remaining 20 GB may be set as the protection area (PA). The operation of reducing the storage space described above may be performed by changing a setting value of a master boot record of the storage medium 200.

In an operation S640, the host 100 and the storage medium 200 may be rebooted.

In an operation S650, the host 100 may recognize a storage space of the storage medium 200 based on the master boot record (MBR) of the storage medium 200. As described above, the area set as the protection area (PA) may not be recognized by the host 100. In the case where capacity of the storage medium 200 is 120 GB and 20 GB is set as the protection area (PA), the host 100 may recognize only a storage space of 100 GB based on the master boot record (MBR) of the storage medium 200.

In the operation S660, the host 100 may transmit a device status request to the storage medium 200. The device status request may be embodied by a vendor specific command, reserve commands, or a combination thereof.

In an operation S670, the storage medium 200 may transmit device status to the host 100. The device status may include information about initial storage capacity of the storage medium 200. The initial storage capacity may indicate physical storage capacity of the storage medium 200. The initial storage capacity may indicate the sum of a storage space capable of being recognized by the host 100 and a storage space set as the protection area (PA).

In an operation S680, the host 100 may manage the protection area (PA) based on the recognized storage space and the device status. For example, as described above, in the case where a size of the recognized storage space is 100 GB and the initial storage capacity included in the received device status is 120 GB, the host 100 may manage the protection area (PA) of 20 GB separately. A management of the protection area (PA) may be performed by the protection area manager 110. The management of the protection area (PA) may be managed as a logical block address (LBA) having a range greater than a logical block address (LBA) of the storage space recognized by the host 100.

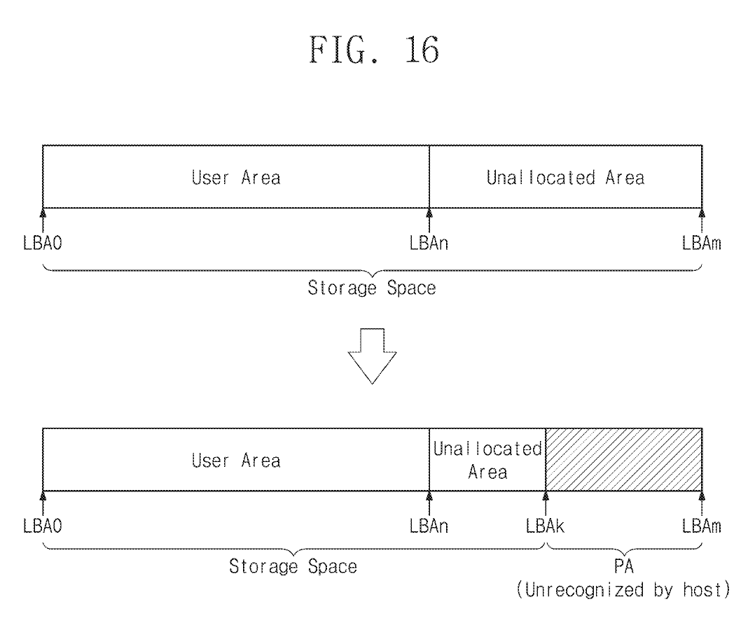

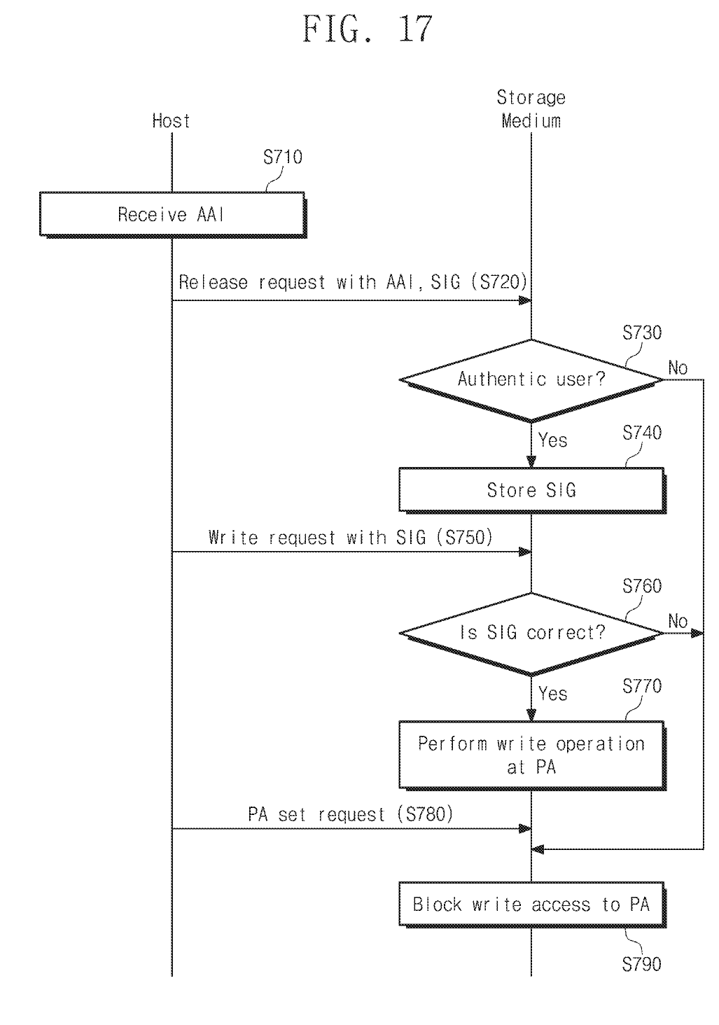

FIG. 16 is a view for explaining a method of setting a protection area of FIG. 15. For brevity of description, constituent elements not necessary for describing the method of setting a protection area of FIG. 15 are omitted.

Referring to FIGS. 1 and 16, a storage space recognized by the host 100 may include a user area and an unallocated area. The user area may be similar to the normal area described with reference to FIG. 5. That is, the user area indicates a storage space which can be recognized by the host 100 and can be freely accessed by various application programs. The user area may be divided into at least one partition.

The unallocated area indicates an area which is recognized by the host 100 but is not designated as a separate partition. That is, the host 100 may recognize the unallocated area. However, since the unallocated area is not designated as a separate partition, it may not be accessed by the host 100 or various application programs.

The unallocated area may be used as a reserve area or an overprovisioning area of the storage medium 200. The FTL 212 of the storage medium 200 may use memory blocks corresponding to the unallocated area when performing an operation such as wear leveling, bad block management, garbage collection, etc.

The storage space recognized by the host 100 may be a storage space of LBA0 to LBAm. Among the storage space of LBA0 to LBAm, the user area may be managed as a storage space of LBA0 to LBAn and the unallocated area may be managed as a storage space of LBAn to LBAm.

After a protection area (PA) setting is performed, the storage space may be reduced to LBA0 to LABk. The remaining storage space (i.e., LBAk to LBAm) may be set as the protection area (PA). The storage space set as the protection area (PA) may not be recognized by the host 100.

For example, the storage medium 200 may set the protection area (PA) in response to a protection area setting request of the host 100, as described with reference to S630. In this case, the storage medium 200 may reduce a size of the storage space recognized by the host 100 as illustrated in FIG. 16. The storage medium 200 may reduce the size of the storage space recognized by the host 100 by changing a setting value of a master boot record (MBR).

After the protection area (PA) setting is completed and the user system 10 is rebooted, the host 100 may recognize the space of LBA0 to LBAk as a storage space of the storage medium 200. That is, the host 100 may not recognize the protection area (PA).

According to at least some example embodiments of the inventive concepts, the host 100, in particular the protection area manager 110 of the host 100 may manage the protection area (PA) as the space of LBAk to LBAm through the operation of S670. For example, since the host 100 cannot recognize the storage space of LBAk to LBAm, the host 100 or various application programs of the host 100 may not perform a write or read request with respect to logical block addresses of LBAk to LBAm. However, the protection area manager 110 may manage the protection area (PA) as the space of LBAk to LBAm and may perform an access to the space of LBAk to LBAm set as the protection area (PA) using a separate command or specific information according to an explicit request of a user.

In the description that follows, a method of accessing the protection area (PA) not recognized by the host 100 is described.

FIG. 17 is a flowchart illustrating a write operation with respect to a protection area of a host and a storage medium of FIG. 1. It is assumed that the host 100 and the storage medium 200 are in a state where a protection area is set through the protection area setting method described with reference to FIG. 15. That is, the host 100 may not recognize the protection area (PA) and a write operation with respect to the protection area (PA) may be performed by the protection area manager 110.

Referring to FIGS. 1 and 17, in an operation S710, the host 100 may receive access authentication information (AAI) from a user. Since an operation of S710 is similar to the operations of S311 of FIG. 7 and S321 of FIG. 8, a detailed description thereof is omitted.

In an operation S720, the host 100 may transmit a release request to the storage medium 200. The release request may be similar to the release request of S312 of FIG. 7. The release request includes access authentication information (AAI) and a signature (SIG). The signature (SIG) is information indicating that the transmitted request occurs from the protection area manager 110. The signature (SIG) may be a predetermined or, alternatively, desired value known to (e.g., stored at) both the protection area manager 110 and the storage medium 200, or may include a value generated by a predetermined or, alternatively, desired algorithm.

In an operation S730, the storage medium 200 may determine whether the release request is a request from an authenticated user in response to the received release request. Since an operation of S730 is similar to the operation of S313 of FIG. 7, a detailed description thereof is omitted.

In the case where the release request is a request from an authenticated user, in an operation S740, the storage medium 200 may store the signature (SIG). For example, the storage medium 200 may store the signature (SIG) in a separate storage area (e.g., the SRAM 214 of FIG. 3).

After that, in an operation S750, the host 100 may transmit a write request including the signature (SIG) to the storage medium 200.

In an operation S760, the storage medium 200 may determine whether the received signature (SIG) is correct. For example, the storage medium 200 may determine whether the received signature (SIG) is correct by comparing whether the signature (SIG) stored in the operation S740 is the same as the signature (SIG) stored in the operation S750.

In the case where the received signature (SIG) is correct, it may be guaranteed that the received write request is a write request by the protection area manager 110 of the host 100. In this case, in an operation S770, the storage medium 200 may perform a write operation with respect to the protection area (PA) in response to the received write request.

In an operation S780, the host 100 may transmit a protection area (PA) setting request to the storage medium 200. For example, the host 100 may transmit a setting request for resetting the protection area to the storage medium 200 by an explicit request from a user. Alternatively, to protect data stored in the protection area (PA), the host 100 may transmit a setting request for resetting the protection area to the storage medium 200 after a predetermined or, alternatively, desired period of time elapses from when the protection area (PA) is released without an explicit request from a user.

In an operation S790, the storage medium 200 may reset the protection area (PA) in response to the setting request from the host 100. In the operation S790, resetting the protection area (PA) may mean blocking a write request to the protection area (PA). A write access request with respect to the protection area (PA) from other application programs, in particular malicious programs besides the protection area manager 110 may be blocked by resetting the protection area (PA).

In the case where the release request is not a request from an authenticated user or the signature (SIG) is not correct, the storage medium 200 may perform an operation of S790.

As described above, the storage medium 200 may provide the protection area (PA) which is not identified by the host 100. In this case, the protection area manager 110 of the host 100 may perform a write operation with respect to the protection area (PA) using the access authentication information (AAI) and the signature (SIG).

The signature (SIG) may be included in a reserve area of the write request from the host 100. In this case, a write operation with respect to the protection area (PA) which is not recognized is possible without a change of a predetermined or, alternatively, desired interface.

The write request requesting to write data to the protection area (PA) may include a logical block address corresponding to the protection area (PA). For example, the write request requesting to write data to the protection area (PA) may include information of one or more other logical block addresses besides logical block addresses corresponding to the storage space identified by the host 100. In the case where a write request not including the signature (SIG) is received to the storage medium 200 or the received signature (SIG) is not correct, the storage medium 200 may not perform a write operation with respect to the received write request and may transmit a response such as an out-of-range of address.

Although not illustrated in the drawing, a read operation may also be performed in a manner similar to that in which the operation method illustrated in FIG. 17 is performed. For example, the host 100 may perform the operations of S710 to S740. After that, the host 100 may transmit a read request including the signature (SIG) to the storage medium 200. The storage medium 200 may determine whether the signature (SIG) included in the received read request is correct. In the case where the signature (SIG) included in the received read request is correct, the storage medium 200 may perform a read operation with respect to the protection area (PA). After that, the host 100 and the storage medium 200 may perform the operations of S780 and S790.

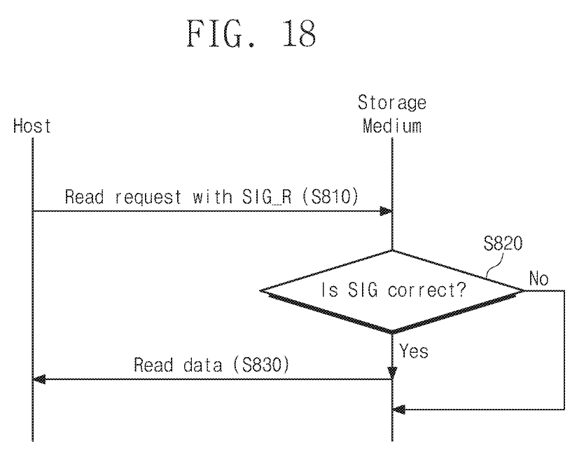

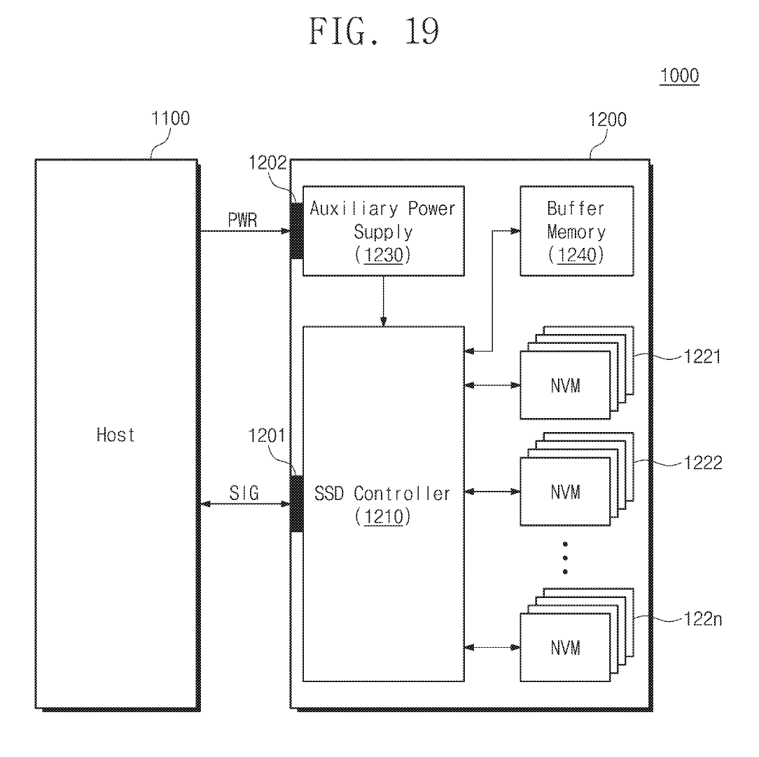

FIG. 18 is a flowchart illustrating a read operation with respect to a protection area of a host and a storage medium of FIG. 1. It is assumed that the host 100 and the storage medium 200 are in a state where a protection area is set through the protection area setting method described with reference to FIG. 15. That is, the host 100 may not recognize the protection area (PA) and a read operation with respect to the protection area (PA) may be performed by the protection area manager 110 of the host 100.

A write operation with respect to the protection area (PA) may be performed through the authentication procedure described with reference to FIG. 17. However, a read operation with respect to the protection area (PA) may be performed without the authentication procedure described with reference to FIG. 17. For example, in the case where a user cannot input access authentication information, a read operation for moving data stored in the protection area (PA) to other storage medium may be performed. In this case, the read operation with respect to the protection area (PA), unlike the signature (SIG) described with reference to FIG. 17, may be performed using a predetermined or, alternatively, desired read signature (SIG_R).

For example, referring to FIGS. 1 and 18, in an operation S810, the host 100 may transmit a read request with respect to the protection area (PA) to the storage medium 200. The read request with respect to the protection area (PA) may include the logical block address of the protection area (PA) described with reference to FIG. 16.

The read request with respect to the protection area (PA) may include the read signature (SIG_R). The read signature (SIG_R), unlike the signature (SIG) described with reference to FIG. 17, may be a signature (SIG) for a read operation. The signature (SIG_R) of FIG. 18 may be a fixed value while the signature (SIG) of FIG. 17 may be changed according to time when a write request occurs or a predetermined or, alternatively, desired algorithm. That is, the read signature (SIG_R) may be information indicating that the protection area manager 110 is accessing the protection area (PA).

In an operation 8820, the storage medium 200 may determine whether the received read signature (SIG_R) is correct. The read signature (SIG_R) may be a predetermined or, alternatively, desired value or a fixed value.

In the case where the read signature (SIG_R) is correct, in an operation S830, the storage medium 200 may provide read data according to the received read request to the host 100. In the case where the read signature (SIG_R) is not correct, the storage medium 200 may not perform a separate operation. In the case where the read signature (SIG_R) is not correct, the storage medium 200 may also provide a separate response (e.g., an out-of-range of address) to the host 100.

As described above, the storage medium 200 may provide the protection area (PA) which is not recognized by the host 100. At this time, the host 100 may transmit a read request including a predetermined or, alternatively, desired read signature (SIG_R) to the storage medium 200. Since the read request with respect to the protection area (PA) includes a logical block address of the protection area (PA) which is not recognized by the host 100 (e.g., not recognized by the host 100, generally, but known to the protected area manager 110), in the case where the read signature (SIG_R) is not correct, the storage medium 200 may provide a request such as an out-of-range of address to the host 100 and may not output separate read data.

As described above, the host and storage medium according to at least some example embodiments of the inventive concepts can protect data stored in the protection area from malicious programs by allocating the protection area among a storage space of the storage medium and performing an authentication operation with respect to the allocated protection area.

In the case where the protection area is recognized by the host, an incorrect operation between the host and the storage medium may be prevented by setting partition information or property information as a read-only.

In the case where the protection area is not recognized by the host, the host may use the signature (SIG) to access the protection area (PA). The signature (SIG) may be information indicating that an access request with respect to the protection area (PA) is an access request from the host 100, in particular the protection area manager 110.

The signature (SIG) for a write operation with respect to the protection area (PA) may be a value provided by the host 100 or a value defined by a predetermined or, alternatively, desired algorithm between the host 100 and the storage medium 200. The read signature (SIG_R) for a read operation with respect to the protection area (PA) may be a value provided by the host 100 or a value predetermined or, alternatively, desired by the host 100 and the storage medium 200.

FIG. 19 is a block diagram illustrating a solid state drive (SSD) system to which at least some example embodiments of the inventive concepts are applied. Referring to FIG. 19, the SSD system 1000 includes a host 1100 and a SSD 1200.

The host 1100 can drive various applications, a protection area manager, or a pre-boot manager as described with reference to FIGS. 1 through 18.

The SSD 1200 may exchange a signal SIG with the host 1100 through a signal connector 1201 and may receive power PWR through a power connector 1202. The SSD 1200 includes a SSD controller 1210, a plurality of flash memories (1221 to 122n), an auxiliary power supply device 1230, and a buffer memory 1240.

The SSD controller 1210 may control the plurality of flash memories (1221 to 122n) in response to the signal SIG received from the host 1100. The plurality of flash memories (1221 to 122n) may operate under the control of the SSD controller 1210. The SSD controller 1210 may include the authentication manager described with reference to FIGS. 1 through 14 and may perform an authentication operation with reference to an access request from the host 1100. The SSD controller 1210 may process the access request from the host 100 according to a result of the authentication operation.

The auxiliary power supply device 1230 is connected to the host 1100 through the power connector 1002. The auxiliary power supply device 1230 may receive power from the host 1100 to be charged. In the case where power is not smoothly supplied from the host 1100, the auxiliary power device 1230 may supply power of the SSD 2200. The auxiliary power supply device 1230 may be located inside or outside the SSD 1200. For example, the auxiliary power supply device 1230 is located on a main board and may provide auxiliary power to the SSD 1200.

The buffer memory 1240 operates as a buffer memory. The buffer memory 1240 may temporarily store data received from the host 1100, data received from the plurality of flash memories (1221 to 122n), or meta data (e.g., mapping table) of the flash memories (1221 to 122n). The buffer memory 1240 may temporarily store various information required when the SSD controller 1210 operates. For example, the buffer memory 1240 may be configured to store information such as the initial authentication information (IAI), the protection area information (PAI), the authentication manager, etc. described with reference to FIGS. 1 through 14. The SSD controller 1210 may perform the operations described with reference to FIGS. 1 through 14 based on the information stored in the buffer memory 1240.

The user system according to at least some example embodiments of the inventive concepts can protect data of a protection area from a malicious program by setting the protection area and performing a separate authentication operation with respect to an access request to the set protection area.

The user system can also prevent an incorrect operation in a host by setting the set protection area as a read-only area to prevent an access request of an operating system or other application to the protection area. Thus, a method of operating storage medium having improved reliability, a method of operating a host that controls the storage medium, and a method of operating a user system including the storage medium and the host are provided.

Example embodiments of the inventive concepts having thus been described, it will be obvious that the same may be varied in many ways. Such variations are not to be regarded as a departure from the intended spirit and scope of example embodiments of the inventive concepts, and all such modifications as would be obvious to one skilled in the art are intended to be included within the scope of the following claims.

What is claimed is:

1. A method of operating a host controlling a storage medium, the method comprising:
receiving initial authentication information;
setting a portion of a storage space of the storage medium as a protection area;
transmitting the received initial authentication information and protection area information with respect to the protection area to the storage medium; and
discarding the initial authentication information in the host.

2. The method of claim 1, wherein the protection area information includes a range of logical block addresses corresponding to the protection area.

3. The method of claim 1, further comprising:
backing up at least some of data stored in a remaining portion to the protection area, the remaining portion being a portion of the storage space other than the portion of the storage space that was set as the protection area.

4. The method of claim 3, further comprising:
setting access rights of the data backed up to the protection area as read-only.

5. The method of claim 1, wherein the setting a portion of a storage space of the storage medium as a protection area comprises:
dividing the storage space of the storage medium into a first partition and a second partition;
setting the first partition as a normal area and setting the second partition as the protection area; and
setting access rights of the second partition as read-only.

6. The method of claim 5, further comprising:
receiving access authentication information; and
providing the access authentication information and an access request for accessing the protection area to the storage medium.

7. The method of claim 6, further comprising:
discarding, at the host, the access authentication information.

8. The method of claim 1, further comprising:
receiving a serial number;
providing the received serial number and a release request for releasing the protection area to the storage medium.

9. The method of claim 1, further comprising:
loading a shadow master boot record from the storage medium;
executing a pre-boot manager based on the shadow master boot record; and
backing up protection data stored in the protection area to a secondary storage recognized by the pre-boot manager.

10. The method of claim 1, further comprising:
receiving reset initial authentication information;
transmitting the reset initial authentication information and a request for resetting the initial authentication information to the storage medium; and
discarding the reset initial authentication information.

11. A method of operating a user system including a storage medium and a host that controls the storage medium, the method comprising:
receiving, by the host, initial authentication information;
setting, by the host, a portion of a storage space of the storage medium as a protection area;
transmitting, by the host, the received initial authentication information and protection area information with respect to the protection area to the storage medium;
storing, by the storage medium, the received initial authentication information and the received protection area information in a nonvolatile memory included in the storage medium; and
discarding, by the host, the initial authentication information in the host.

12. The method of claim 11, further comprising:
receiving, by the host, access authentication information;
providing, by the host, the access authentication information and an access request to the storage medium;
performing, by the storage medium, an authentication operation based on the access authentication information and the initial authentication information; and
performing selectively, by the storage medium, an operation with respect to the access request according to a result of the authentication operation.

13. The method of claim 12, wherein the performing selectively, by the storage medium, an operation with respect to the access request according to a result of the authentication operation comprises:
if the result of the authentication operation indicates an authentication state, performing, by the storage medium, the operation with respect to the access request; and
if the result of the authentication operation indicates an non-authentication state, not performing, by the storage medium, the operation with respect to the access request.

14. The method of claim 11, wherein the setting comprises:
dividing, by the host, the storage space of the storage medium into a first partition and a second partition;
setting, by the host, the first partition as a normal area and setting the second partition as the protection area; and
setting access rights of the second partition as a read-only.

15. The method of claim 11, wherein the setting comprises:
setting, by the host, access rights of data stored in the protection area as a read-only.

16. A method of operating a storage medium, the method comprising:
receiving initial authentication information at the storage medium;
storing the initial authentication information in the storage medium;
setting a portion of a storage space of the storage medium as a protection area;
receiving access authentication information and a data access request for accessing data stored in the protection area; and
selectively processing the data access request based on the received access authentication information and the stored initial authentication information.

17. The method claim 16 wherein the selective processing comprises:
determining whether the received access authentication information has a first relationship with the stored initial authentication information;
processing the data access request if the received access authentication information has the first relationship with the stored initial authentication information; and
rejecting the data access request if the received access authentication information does not have the first relationship with the stored initial authentication information.

18. The method claim 16, wherein the access authentication information and the data access request are received at the storage device from a host.

19. The method of claim 16 further comprising:
receiving protection area information at the storage device,
wherein the storing includes storing the received initial authentication information in accordance with the received protection area information.

20. The method of claim 19, wherein the initial authentication information and the protection area information are received at the storage device from a host.
